(19) United States
(12) Patent Application Publication
(10) Pub. No.: US 2002/0045692 A1
(43) Pub. Date: Apr. 18, 2002

(54) Use of a powder composition for hydrophobicizing construction compositions

(75) Inventors: Wolfgang Fiedler, Eppstein (DE); Ulrich Geissler, Hochheim (DE); Ludwig Schmitz, Buerstadt (DE)

Correspondence Address: Clariant Corporation, Industrial Property Department, 4331 Chesapeake Drive, Charlotte, NC, 28216, US

(73) Assignee: Clariant GmbH

(21) Appl. No.: 09/969,372

(22) Filed: Oct. 2, 2001

(30) Foreign Application Priority Data
Oct. 2, 2000 (DE) 100 49 072.7
Jan. 12, 2001 (DE) 101 01 190.3

(51) Int. Cl. C08K 5/10; C08K 9/00

(52) U.S. Cl. 524/315; 524/316; 524/317; 524/318

(57) ABSTRACT

The invention relates to the use of a powder composition which comprises at least one carboxylic ester, for hydrophobicizing construction compositions.

### BACKGROUND OF THE INVENTION

The present invention relates to the use of a powder composition which comprises at least one carboxylic ester, for hydrophobicizing construction compositions.

1. Field of the Invention

Ever since mankind has erected artificial dwellings a concern has been the penetration of moisture into these dwellings. The exposure to weather-related phenomena such as rain and snow can be minimized by appropriate construction, e.g. roofs with substantial overhang. However, this does not control absorption of water by the construction materials as a result of their capillary action. This can result in leeching of salts, causing irreversible damage to the cement and therefore damage to the entire mortar composite. Prevention of this effect requires that building works are either subsequently coated with tar emulsions, bitumen emulsions, wax emulsions, or paraffin emulsions, or are impregnated.

2. Description of the Related Art

The addition of fatty acid carboxylates has long been recommended (see Horst Reul, Handbuch Bauchemie, Verlag für chem. Industrie, H. Ziolkowsky KG, Augsburg, 1991, pp. 111 et seq.). However, these compounds have limited effectiveness, resulting in increased utilization of organosilicon compounds and emulsions in recent times.

EP-A-0 741 760 draws attention to the possibility of adding organosilicon compounds or emulsions of these to dispersions and then converting these into redispersible powders by spray drying.

DE-A-44 02 408 describes the formulation and preparation of redispersible silicon-modifying dispersion powders which comprise copolymerized organosilicon units.

EP-A-0 824 510 describes the hydrophobicization of construction compositions by means of emulsions of organosilicon compounds.

DE-A-197 52 659 discloses organosilicon-containing hydrophobicizing powders using silicas as carrier materials for these substances.

However, a disadvantage with the use of organosilicon compounds is their poor biodegradability and the unfavorable ecobalance of their preparation, which generates pollutants.

DE-A-195 32 426 discloses water-redispersible powders comprising carboxylic ester. It uses these for reducing the air content of fresh mortars, but says nothing about their effect on water absorption and does not refer to the hydrophobicizing effect of this class of compound.

### SUMMARY OF THE INVENTION

The object of the present invention was therefore to provide construction compositions which, while they comprise no organosilicon-containing compounds, bring about comparable hydrophobicization.

The present invention therefore provides the use of a powder composition which comprises at least one carboxylic ester, for hydrophobicizing construction materials.

### DESCRIPTION OF THE PREFERRED EMBODIMENTS

Both the acid component and the alcohol component of the carboxylic esters may be either saturated or unsaturated, and either branched or unbranched. The acid radical and the alcohol radical may also contain halogens, such as fluorine or chlorine, and hydroxyl groups, ether groups, thioether groups, ester groups, amide groups, carboxy groups, sulfonic acid groups, carboxylic anhydride groups, and/or carbonyl groups.

To improve water-solubility, the carboxylic esters may contain polyethylene oxide units as spacers between carboxylic acid component and alcohol component. The number of polyethylene oxide units is preferably from 1 to 80 and particularly preferably from 2 to 40. Preference is given to carboxylic esters of the formula CₙH₍₂ₙ₊₁₎COOCₘH₍₂ₘ₊₁₎, where n=from 6 to 22 and m=from 1 to 8, preferably where n=from 10 to 14 and m=from 1 to 4. Methyl laurate and/or ethyl laurate are particularly preferred as carboxylic ester.

In one preferred embodiment the powder used comprises a redispersible dispersion powder composition which comprises from 0.1 to 30% by weight, based on the total weight of the dispersion powder composition, of at least one carboxylic ester.

Particular preference is given to a dispersion powder composition comprising

at least one water-insoluble polymer selected from the group consisting of the vinyl ester, vinyl ester-ethylene, vinyl chloride, (meth)acrylate, styrene-(meth)acrylate homo- and/or copolymers,

from 0 to 35% by weight, based on the total weight of the polymer, of at least one protective colloid,

from 0 to 30% by weight, based on the total weight of the polymer, of anticaking agents, and

from 0.1 to 30% by weight, based on the total weight of the polymer, of at least one carboxylic ester.

Suitable water-insoluble polymers are homo- or copolymers that are in the form of an aqueous dispersion or that can be converted into an aqueous dispersion, and which, where appropriate at an elevated temperature and/or in an alkaline medium, and after drying and, where appropriate, curing, form a solid film. The average particle size of the powder is preferably from 1 to 1000 μm, particularly preferably from 10 to 700 μm, and in particular from 50 to 500 μm.

Preferred water-insoluble polymers are:

vinyl ester homo- or copolymers containing one or more monomer units selected from the group consisting of the vinyl esters of unbranched or branched alkylcarboxylic acids having from 1 to 15 carbon atoms;

vinyl ester homo- or copolymers containing one or more monomer units selected from the group consisting of the vinyl esters of unbranched or branched alkylcarboxylic acids having from 1 to 15 carbon atoms and ethene;

vinyl ester homo- or copolymers containing one or more monomer units selected from the group consisting of the vinyl esters of unbranched or branched alkylcarboxylic acids having from 1 to 15 carbon atoms and (meth)acrylates;

vinyl ester homo- or copolymers containing one or more monomer units selected from the group consisting of the vinyl esters of unbranched or branched alkylcarboxylic acids having from 1 to 15 carbon atoms, (meth)acrylates and ethene;

(meth)acrylate homo- or copolymers containing one or more monomer units selected from the group consisting of the methacrylates and acrylates of unbranched or branched alcohols having from 1 to 12 carbon atoms;

(meth)acrylate homo- or copolymers containing one or more monomer units selected from the group consisting of the methacrylates and acrylates of unbranched or branched alcohols having from 1 to 12 carbon atoms and styrene;

homo- or copolymers of fumaric and/or maleic mono- or diesters of unbranched or branched alcohols having from 1 to 12 carbon atoms;

homo- or copolymers of dienes, e.g. butadiene or isoprene, or else of olefins, e.g. ethene or propene, where the dienes may be copolymerized with, for example, styrene, (meth)acrylates, or with the esters of fumaric or maleic acid;

homo- or copolymers of vinylaromatics, e.g. styrene, methylstyrene, or vinyltoluene;

homo- or copolymers of vinyl halogen compounds, e.g. vinyl chloride.

Water-insoluble, film-forming polyaddition or polycondensation polymers are likewise suitable, e.g. polyurethanes, polyesters, polyethers, polyamides, melamine-formaldehyde resins, and phenyl-formaldehyde resins, and, where appropriate, the oligomeric precursors of these.

Preferred vinyl esters are vinyl acetate, vinyl propionate, vinyl butyrate, vinyl

2-ethylhexanoate, vinyl laurate, 1-methylvinyl acetate, vinyl pivalate and vinyl esters of α,α-dialkyl-branched monocarboxylic acids having up to 15 carbon atoms, such as VeoVa9®, VeoVa10®, or VeoVa 11®. Particular preference is given to vinyl acetate and VeoVa10®.

Preferred methacrylates and acrylates are methyl acrylate, methyl methacrylate, ethyl acrylate, ethyl methacrylate, propyl acrylate, propyl methacrylate, n-butyl acrylate, tert-butyl acrylate, n-butyl methacrylate, tert-butyl methacrylate, and 2-ethylhexyl acrylate. Particular preference is given to methyl methacrylate, n-butyl acrylate, and 2-ethylhexyl acrylate.

Preferred ester groups of fumaric or maleic acid are methyl, ethyl, n-propyl, isopropyl, n-butyl, isobutyl, tert-butyl, hexyl, ethylhexyl, and dodecyl.

The vinyl ester copolymers may contain from 1.0 to 65% by weight, based on the total weight of the monomers, of a-olefins, e.g. ethene and propene, and/or vinylaromatics, e.g. styrene, and/or vinyl halides, e.g. vinyl chloride, and/or acrylates of alcohols having from 1 to 12 carbon atoms, or methacrylates of these alcohols, e.g. methyl acrylate, methyl methacrylate, ethyl acrylate, ethyl methacrylate, propyl acrylate, propyl methacrylate, n-butyl acrylate, tert-butyl acrylate, n-butyl methacrylate, tert-butyl methacrylate or 2-ethylhexyl acrylate, and/or ethylenically unsaturated dicarboxylic acids and/or derivatives of these, e.g. diisopropyl fumarate, dimethyl, methyl tert-butyl, di-n-butyl, di-tert-butyl, or diethyl maleate and/or fumarate, or maleic anhydride.

The (meth)acrylate copolymers may contain from 1.0 to 65% by weight, based on the total weight of the monomers, of a-olefins, e.g. ethene and propene, and/or vinylaromatics, e.g. styrene, and/or vinyl halides, e.g. vinyl chloride, and/or ethylenically unsaturated dicarboxylic acids and/or derivatives of these, e.g. diisopropyl fumarate, dimethyl, methyl tert-butyl, di-n-butyl, di-tert-butyl, and diethyl maleate and/or fumarate, or maleic anhydride.

The vinyl ester copolymers and (meth)acrylate copolymers may moreover contain from 0.05 to 10.0% by weight, based on the total weight of the monomers, of auxiliary monomers from the group consisting of the ethylenically unsaturated carboxylic acids, preferably acrylic acid or methacrylic acid, from the group consisting of the ethylenically unsaturated carboxamides, preferably acrylamide, from the group consisting of the ethylenically unsaturated sulfonic acids and salts of these, preferably vinylsulfonic acid or 2-acrylamido-2-methylpropanesulfonic acid (AMPS), and/or from the group consisting of the multiply ethylenically unsaturated comonomers, such as divinyl adipate, diallyl maleate, allyl methacrylate, or triallyl cyanurate. Other suitable auxiliary monomers are crosslinking comonomers, e.g. acrylamidoglycolic acid (AGA), methyl methacrylamidoglycolate (MAGME),

N-methylolacrylamide (NMAA), N-methylolmethacrylamide, allyl N-methylcarbamate, alkyl ethers, e.g. the isobutoxy ether, or esters of N-methylolacrylamide, of

N-methylolmethacrylamide, or of allyl N-methylcarbamate. The same applies to the copolymers of the maleic or fumaric esters.

The water-insoluble polymers mentioned are capable of free-radical polymerization and are preferably prepared by emulsion polymerization. This polymerization may be carried out batchwise or continuously, with or without the use of seed lattices, the initial charge comprising one or more, or all, of the constituents of the reaction mixture, or by the feed process with no initial charge. The rate of each feed preferably corresponds to the consumption of the respective component. The polymerization is preferably carried out in the temperature range from 0 to 100° C. and initiated by the methods usually used for emulsion polymerization. It is usually initiated by means of conventional water-soluble free-radical generators, preferably used in amounts of from 0.01 to 3.0% by weight, based on the total weight of the monomers. Examples of suitable water-soluble initiators are sodium peroxodisulfate, potassium peroxodisulfate, and ammonium peroxodisulfate, and also water-soluble azo initiators. Any protective colloids and/or emulsifiers usually used in emulsion polymerization may be used as dispersing agents.

Where appropriate, up to 6% by weight of emulsifiers may be used, based on the total weight of the monomers. Emulsifiers which may be used here are either anionic, cationic, or nonionic emulsifiers.

In the particularly preferred embodiment, the dispersion powder composition comprises from 0 to 35% by weight, preferably from 3 to 15% by weight, of protective colloid, based on the total weight of the water-insoluble polymer.

Suitable protective colloids are polyvinyl alcohols and derivatives of these, e.g. vinyl alcohol-vinyl acetate copolymers, polyvinylpyrrolidones, polysaccharides, e.g. starches (amylose and amylopectin), cellulose, guar, tragacantic acid, dextran, alginates and carboxymethyl, methyl, hydroxyethyl, or hydroxypropyl derivatives, proteins, e.g. casein, soya protein, gelatins, synthetic polymers, e.g. poly(meth)acrylic acid, poly(meth)acrylamide, polyvinylsulfonic acids, and water-soluble copolymers of these, melamine-formaldehydesulfonates, naphthalene-formaldehydesulfonates, styrene/maleic acid copolymers, and vinyl ether-maleic acid copolymers. Polyvinyl alcohol is particularly preferred as protective colloid for the polymerization. A particular protective colloid used is a polyvinyl alcohol with a degree of polymerization of from 200 to 3 500 and with a degree of hydrolysis of from 80 to 98 mol %.

Preferred anticaking agents are aluminum silicates, carbonates of calcium or of magnesium, or mixtures of these, silicas, or mixtures of dolomite and talc, or of calcite and talc. The particle size of the anticaking agents is preferably in the range from 0.001 to 0.5 mm.

If solubility in water is sufficient, it is preferable for the carboxylic esters to be added in pure form to the emulsion polymer. Otherwise, the carboxylic esters are added in emulsified form. For the emulsification it is preferable to use protective colloids, where appropriate combined with suitable emulsifiers. Emulsifiers used here may be either anionic, cationic, or nonionic emulsifiers.

It is also preferable for the carboxylic esters to be added to the aqueous phase of the emulsion polymerization. The carboxylic esters may also be used as a feed during the emulsion polymerization.

The dispersion powder composition is preferably prepared by spray drying. This drying takes place in conventional spray drying systems, using atomization by means of single-, twin-, or multiple-fluid nozzles or by a rotating disk. The discharge temperature selected is generally in the range from 50 to 100° C., preferably from 60 to 90° C., depending on the system, the glass transition temperature of the resin, and the desired degree of drying. To increase the storage stability and flowability of the dispersion powder it is preferable to introduce an anticaking agent into the spray tower in parallel with the dispersion, the result being the preferred deposition of the anticaking agent onto the dispersion particles.

The carboxylic esters are also effective if they are adsorbed onto inorganic carrier materials, in particular silica, as is described in detail in DE-A-195 35 833 and DE-A-197 52 659.

In another preferred embodiment, the powder used and comprising the at least one carboxylic ester comprises an inorganic carrier material which comprises from 5 to 160% by weight, based on the weight of the carrier material used, of at least one adsorbed carboxylic ester.

Preferred carrier materials used here are silica, anticaking agents, magnesium hydrosilicates, fine-particle titanium dioxide, aluminas, bleaching earths, activated aluminum oxide, vermiculite, e.g. bentonite, expanded perlite, and/or phosphates, e.g. sodium phosphate. It is particularly preferable to use silica as carrier material for the at least one carboxylic ester.

The silica may be fumed silica or precipitated silica. These grades of silica have a high degree of dispersion and preferably have a BET surface area of at least 50 m²/g, particularly preferably at least 100 m²/g.

These coated products are preferably used as anticaking agents and admixed during the atomization process. They are particularly preferably admixed with the finished dispersion powder or directly with the construction compositions.

The present invention also provides the use of a powder composition comprising a silica coated with at least one carboxylic ester and comprising a redispersible dispersion powder, for hydrophobicizing construction compositions, where the redispersible dispersion powder may likewise comprise carboxylic ester.

The construction compositions may in particular be coating compositions or mineral construction mixes for producing mineral components. The coating compositions are used in particular for mineral substrates. The coating compositions may be purely solvent-based, or be aqueous, or in powder form.

Examples of coating compositions are paints, such as mineral paints, lime paints, silicate paints, emulsion paints, lime emulsion paints, silicate emulsion paints, primers, renders, e.g. mineral renders and silicate renders, highly filled coatings based on dispersions, brush-applied fillers, enforcing compositions, troweling compounds, and tile adhesives, and also mortars, e.g. jointing mortars.

For the purposes of the present invention, mineral construction mixes are any of the raw mixes which can be used to produce mineral components which in turn are used in civil engineering works and are part of the civil engineering works, in particular if they are exposed to weathering or require some other type of water-repellency.

Examples of components are prefabricated bricks and concrete roof tiles, fiber-filled concrete panels, and gypsum plasterboard, and also other finished parts or insulating components. Mineral construction mixes may be composed of concrete, gypsum plaster, lime, cement, quartz sand, clay minerals, such as calcium silicate, porous concrete, bricks, or else of fiber-based construction mixes in which the fibers are natural fibers or synthetic fibers. Suitable natural fibers are mineral fibers, such as rock fiber, quartz fibers, or ceramic fibers, or vegetable fibers, such as cellulose. Examples of the cellulose fibers are jute fibers, coconut fibers, and hemp fibers, or fibers derived from paper, card, or waste paper. Examples of suitable synthetic fibers are glass fibers, polymer fibers, and carbon fibers.

Besides the mineral constituents, the mineral construction compositions may also comprise organic additives, e.g. cellulose ethers or plasticizers. Other organic additives which may be used in the mineral construction compositions are known to the skilled worker (see Horst Reul, Handbuch Bauchemie [Construction chemistry handbook], Verlag für chem. Industrie, H. Ziolkowsky KG, Augsburg, 1991).

The amounts preferably present of the hydrophobicizing powder compositions in the construction compositions are from 0.01 to 80% by weight.

The invention is described in further detail below using examples, but is not limited by these. The parts and percentages stated in the examples are based on weight unless otherwise stated.

### EXAMPLES

### Example 1

1 300 parts of a polyvinyl alcohol-stabilized dispersion based on vinyl acetate, vinyl

10-versatate, and butyl acrylate (45:45:10), solids content: 54.1%, viscosity (Haake VT 500, 386.6 s⁻¹): 1 150 mPas, Tg: 13° C., particle size distribution: d_{w}: 1 863 nm, d_{w}/dₙ: 12.8, preparation based on example 1 of EP-A-0 761 697,

are treated with 140 parts of a 25% strength polyvinyl alcohol solution (viscosity of 4% strength aqueous solution at 20° C.: 4 mPas, degree of hydrolysis: 88%, degree of polymerization: 630).

22.1 parts of the carboxylic esters listed in the table below are added to the mixture in each instance:

| Example No. | Carboxylic ester (number of carbon atoms/alcohol) |
|---|---|
| 1a (comparison) | None |
| 1b | Ethyl caprylate (C7/C2) |
| 1c | Ethyl caprate (C9/C2) |
| 1d | Ethyl laurate (C11/C2) |
| 1e | Ethyl myristate (C13/C2) |
| 1f | Ethyl palmitate (C15/C2) |
| 1g | Methyl laurate (C11/C1) |
| 1h | Butyl laurate (C11/C4) |
| 1i | Methyl myristate (C13/C1) |
| 1j | Isopropyl myristate (C13/isoC3) |

The mixtures are diluted with deionized water to 40% solids content and spray-dried with addition of an anticaking mixture of talc and dolomite (spray drier from Niro, inlet temperature: 130° C., discharge temperature: 65° C., throughput: 1 kg of dispersion/hour). The content of anticaking agent is 15%.

The dispersion powders isolated are used in hydraulically setting compositions, and water absorption values are determined as follows:

A premix is prepared by homogenizing

300 parts Portland cement CEM I 42.5 R

2 parts ®Tylose MH 15002 P6

200 parts Quartz sand F 31

368 parts Quartz sand F 34

100 parts Omyacarb 20 GU

in a Lödige (model M5R) mixer for 3 minutes at scale setting 8.5.

197.5 parts of premix are mixed with 2.5 parts of dispersion powder and, after addition of 40 parts of water, stirred for 15 seconds at a high rotation rate using a Lenart stirrer (Vollrath, model EWTHV-1). The composition is allowed to age for 5 minutes, and is then stirred again manually.

On top of a sheet of EPS, 2 cm in thickness, is placed a template of dimension 0.5×10×20 cm, into which an amount of the composition is uniformly charged and smoothed. After overnight standing, the specimen is cut out and edge-sealed with molten paraffin wax.

The sealed specimens are stored at 23° C., first for 3 days in a water-vapor-saturated atmosphere, then for 3 days at 50% rel. humidity.

The specimens are then weighed and then placed with their test surfaces downward in a water-filled basin. After 1 and, respectively, 24 h the specimens are removed, damped dry with a sponge wipe, and weighed. The increase in weight is converted to g/m².

The water absorption values found for the mortar compositions formulated using the powders 1a to 1j are given in the table below:

| | Water absorption | Water absorption |
|---|---|---|
| Example No. | 1 h (g/m²) | 24 h (g/m²) |
| 1a (comparison) | 508 | 787 |
| 1b | 247 | 536 |
| 1c | 156 | 354 |
| 1d | 104 | 300 |
| 1e | 113 | 314 |
| 1f | 124 | 376 |
| 1g | 93 | 290 |
| 1h | 97 | 282 |
| 1i | 78 | 259 |
| 1j | 201 | 464 |

It can be seen that the water absorption of the construction compositions is markedly reduced by adding carboxylic esters.

### Example 2

50 parts of ® Sipernat 22 (precipitated silica with a BET surface area of 190 m²/g, average agglomerate size 100 μm, 98 % SiO₂) are charged to a kitchen machine and 50 parts of methyl laurate are added dropwise at room temperature within a period of 5 minutes. Stirrer rate: setting 2. After continued stirring for 3 minutes the pulverulent mixture is discharged.

0.4 part of the powder just described is mixed with 199.6 parts of the premix listed in example 1, and water absorption is determined (procedure as in example 1).

The table low gives water absorption in comparison with that of a modified with dispersion powder only:

| | Water absorption | Water absorption |
|---|---|---|
| Example No. | 1 h (g/m²) | 24 h (g/m²) |
| 1a (comparison) | 508 | 787 |
| 2 | 95 | 254 |

It can be seen that the water absorption of the construction composition reduced by adding silica coated with methyl laurate.

1. A method for hydrophobicizing construction compositions, wherein a powder composition is used, which comprises at least one carboxylic ester.

2. A method as claimed in claim 1, wherein the acid component and/or the alcohol component of the carboxylic ester contain halogens, hydroxyl groups, ether groups, thioether groups, ester groups, amide groups, carboxy groups, sulfonic acid groups, carboxylic anhydride groups, and/or carbonyl groups.

3. A method as claimed in claim 1, wherein a carboxylic ester used has the formula CₙH₍₂ₙ₊₁₎COOCₘH₍₂ₘ₊₁₎, where n=from 6 to 22 and m=from 1 to 8.

4. A method as claimed in claim 3, wherein n=from 10 to 14 and m=from 1 to 4.

5. A method as claimed in claim 4, wherein methyl laurate and/or ethyl laurate are used as carboxylic ester.

6. A method as claimed in claim 1, wherein the powder used comprises a redispersible dispersion powder composition which comprises from 0.1 to 30% by weight, based on the total weight of the dispersion powder composition, of at least one carboxylic ester.

7. A method as claimed in claim 6, wherein the dispersion powder composition comprises at least one water-insoluble polymer selected from the group consisting of the vinyl ester, vinyl ester-ethylene, vinyl chloride, (meth)acrylate, styrene-(meth)acrylate homo- and/or copolymers, from 0 to 35% by weight, based on the total weight of the polymer, of at least one protective colloid, from 0 to 30% by weight, based on the total weight of the polymer, of anticaking agents, and from 0.1 to 30% by weight, based on the total weight of the polymer, of at least one carboxylic ester.

8. A method as claimed in claim 7, wherein the polymer a) has been stabilized by means of protective colloids and/or of emulsifiers.

9. A method as claimed in claim 8, wherein polyvinyl alcohol is used as protective colloid in preparing the polymer a).

10. A method as claimed in claim 7, wherein the anticaking agents used comprise aluminum silicate, carbonates of calcium or of magnesium or mixtures of these, silicas, or mixtures of dolomite and talc, or of calcite and talc.

11. A method as claimed in claim 7, wherein the carboxylic ester is added during the preparation of the polymer a).

12. A method as claimed in claim 1, wherein the powder used comprises an inorganic carrier material which comprises from 5 to 160% by weight, based on the weight of the carrier material used, of at least one adsorbed carboxylic ester.

13. A method as claimed in claim 12, wherein the inorganic carrier material used comprises silica, anticaking agents, magnesium hydrosilicates, fine-particle titanium dioxide, aluminas, bleaching earths, activated aluminum oxide, vermiculites, expanded perlite, and/or phosphates.

14. A method as claimed in claim 13, wherein the inorganic carrier material used comprises silica.

15. A method as claimed in claim 12, wherein the composition also comprises a redispersible dispersion powder.

16. A method as claimed in claim 15, wherein the redispersible dispersion powder comprises carboxylic ester.

17. A method as claimed in claim 1, wherein the construction composition is a coating composition or a mineral construction mix for producing mineral components.

18. A method as claimed in claim 1, wherein the building composition comprises from 0.01 to 80% by weight of hydrophobicizing powder composition.
